(19) United States
(12) Patent Application Publication
(10) Pub. No.: US 2007/0069709 A1
(43) Pub. Date: Mar. 29, 2007

(54) Band gap reference voltage generator for low power

(75) Inventors: Chun-Seok Jeong, Kyoungki-do (KR); Sang-Jin Byeon, Kyoungki-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Hynix Semiconductor Inc.

(21) Appl. No.: 11/480,722

(22) Filed: Jun. 30, 2006

(30) Foreign Application Priority Data
Sep. 29, 2005 (KR) 2005-0091664
Dec. 28, 2005 (KR) 2005-0132494

(51) Int. Cl. G05F 3/04; G05F 3/16

(52) U.S. Cl. 323/312; 323/313

(57) ABSTRACT

A band gap reference voltage generation circuit includes an operational amplifier for receiving first and second voltages and outputting an operational amplified signal; a first voltage generator for generating the first voltage in response to the operational amplified signal; a second voltage generator for generating the second voltage in response to the operational amplified signal; a common current path unit connected between output nodes of the first and second voltage generators and generating a current path based on a common voltage level of the first and second voltages; and a reference voltage generator for generating a reference voltage based on the operational amplified signal.

### FIELD OF THE INVENTION

The present invention relates to a semiconductor integrated circuit, and more particularly to a band gap circuit for generating a reference voltage suitable for low power integrated circuits.

### DESCRIPTION OF RELATED ARTS

A band gap reference voltage generation circuit (hereinafter, refer to a BGR circuit) is employed in a semiconductor integrated circuit and supplies a stable bias voltage to the semiconductor integrated circuit.

The BGR circuit mainly supplies a reference voltage to an analog-digital converter (ADC) and a digital-analog converter (DAC) and has a stable characteristic with respect to variation of temperature or variation of process.

Generally, such a BGR circuit stably outputs the reference voltage regardless of the variation of temperature or variation of process based on a junction voltage characteristic of a bipolar junction transistor (BJT), i.e., an emitter-base (E-B) junction voltage, and a thermal voltage characteristic of the BJT, i.e., V_{T}=kT/q.

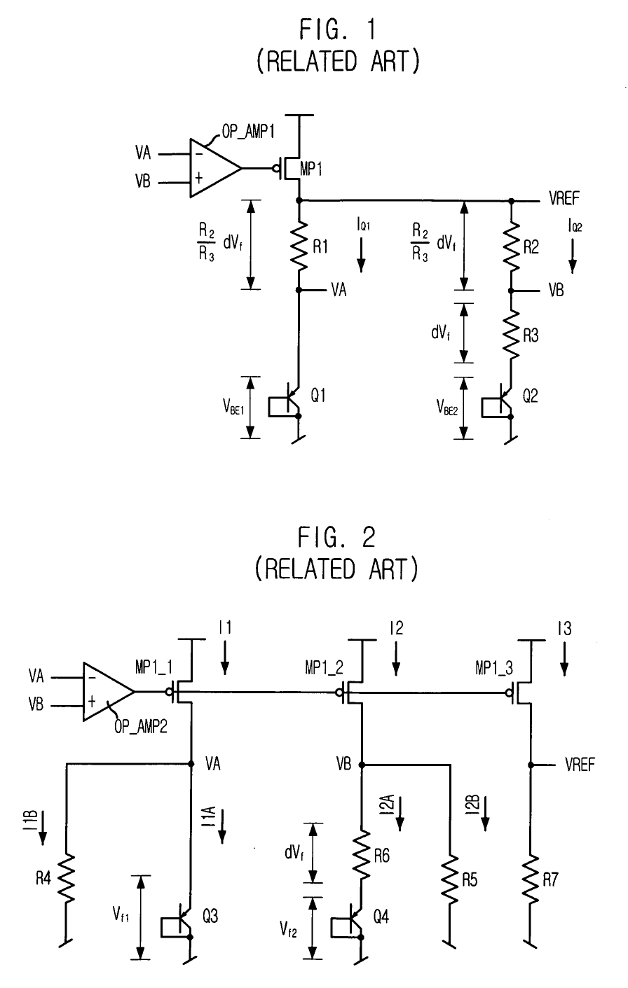

FIG. 1 is a block diagram of a BGR circuit of the related arts.

As shown, the BGR circuit includes an operational amplifier OP-AMP1, a PMOS transistor MP1, first and second diode-connected BJTs Q1 and Q2, and first to third resistors R1, R2 and R3.

In the BGR circuit, a turn-on amount of the PMOS transistor MP1 is determined in response to an output voltage of the operational amplifier OP-AMP1 so as to adjust an amount of current flowing the first to third resistors R1 to R3 through the PMOS transistor MP1 until two input voltages VA and VB of the operational amplifier OP-AMP1 have the same voltage level.

When the two input voltages VA and VB of the operational amplifier OP-AMP1 have the same voltage level, a uniform voltage level is applied to a common node of the first and second resistors R1 and R2 so that a reference voltage VREF is generated with the uniform voltage level.

Hereinafter, the voltage level of the reference voltage VREF is explained with formulas.

Normally, a current I_{Q1, Q2} flowing between the first and second diode-connected BJTs Q1 and Q2 is expressed as Equation 1.
I_{Q1,Q2}=Iₛ*e^{V}^{_{BE}}^{/V}^{_{T}} [Equation 1]

Herein, Iₛ denotes a saturation current having a constant value and V_{T} denotes a thermal voltage which is proportional to an absolute temperature and has a value of kT/q where k is a Boltzman's constant and q is an amount of electric charges.

Continuously, when the two input voltages VA and VB of the operational amplifier OP-AMP1 have the same voltage level, a current I_{R3} flowing between the third resistor R3 is expressed as Equation 2.

$${I}_{R 3} = \frac{{V}_{BE 1} - {V}_{BE 2}}{R 3} \qquad [ Equation 2 ]$$

Meanwhile, if a size ratio of the first and second diode-connected BJTs Q1 and Q2 is N:1, each current, i.e., I_{Q1} and I_{Q2}, flowing between the first and second diode-connected BJTs Q1 and Q2 is expressed as Equation 3.
I_{Q1=}I_{S}*e^{V}^{_{BE1}}^{/V}^{_{T}} [Equation 3]
I_{Q2=}N*I_{S}*e^{V}^{_{BE2}}^{/V}^{_{T}}

Based on Equation 3, a base-emitter (B-E) voltage difference dV_{f} between the first and second diode-connected BJTs Q1 and Q2 is expressed as Equation 4 and the reference voltage VREF is expressed as Equation 5. Herein, because the two input vq,ltages VA and VB of the operational amplifier OP-AMP1 have the same voltage level, a ratio of the current I_{Q1} flowing from the first resistor R1 and the current I_{Q2} flowing from the first resistor R2 is the same ratio as the first resistor R1 and the second resistor R2.

$$\begin{matrix}{dV}_{f} = {V}_{BE 1} - {V}_{BE 2} = {V}_{T} * ln ( \frac{N * R 2}{R 1} ) & [ Equation 4 ] \\ VREF = {V}_{BE 1} + ( \frac{R 2}{R 3} ) * ln ( \frac{N * R 2}{R 1} ) * {V}_{T} & [ Equation 5 ]\end{matrix}$$

Referring to Equation 5, a the base-emitter (B-E) voltage V_{BE1} of the first diode-connected BJT Q1 has a negative value of about −1.5 mV/K with respect to the variation of temperature, and the thermal voltage V_{T} has a positive value of about 0.087 mV/K with respect to the variation of temperature. As a result, the reference voltage VREF which does not sensitively vary according to the variation of temperature may be generated by adjusting (R2/R3)*ln(N*R2/R1).

However, in the related arts, because the reference voltage VREF corresponds to a band gap voltage of silicon having a value of about 1.25V, it is difficult to bring down an operation voltage of the BGR circuit lower than 1.25V.

FIG. 2 is a block diagram of an improved BGR circuit of the related arts for operating under lower voltage circumstances.

Referring to FIG. 2, the improved BGR circuit of the related arts includes an operational amplifier OP_AMP2, first to third PMOS transistors MP1_1, MP1_2 and MP1_3, first and second diode-connected bipolar junction transistors (BJTs) Q3 and Q4, and first to fourth resistors R4, R5, R6 and R7. Herein, the first to third PMOS transistors MP1_1 to MP1_3 have substantially the same dimension, and the first and second resistors R4 and R5 have substantially the same resistance.

The first PMOS transistor MP1_1 is connected between a source voltage and a first voltage VA and has a gate receiving an output voltage of the operational amplifier OP_AMP2. The second PMOS transistor MP1_2 is connected between the source voltage and a second voltage VB and has a gate receiving the output voltage of the operational amplifier OP_AMP2. The third PMOS transistor MP1_3 is connected between the source voltage and a reference voltage VREF and has a gate receiving the output voltage of the operational amplifier OP_AMP2.

The first resistor R4 and the first diode-connected BJT Q3 are connected between the first voltage VA and a ground voltage in parallel, respectively. The second resistor R5 and the second diode-connected BJT Q4 are connected in series between the second VB and the ground voltage. The third resistor R6 is connected between the second voltage VB and the ground voltage and the fourth voltage R7 is connected between the reference voltage VREF and the ground voltage.

Hereinafter, a voltage level of the reference voltage VREF is explained with formulas.

The gates of the first to third PMOS transistors MP1_1 to MP1_3 are connected to the output voltage of the operational amplifier OP_AMP2 in common so that amounts of first to third current I1 to I3 are substantially same. In addition, the first and second voltage VA and VB have the same voltage level because they are inputted to the operational amplifier OP_AMP2. Accordingly, if the first and second resistors R4 and R5 a the same resistance, amounts of second and fourth sub-current I1B and I2B are the same and a voltage difference dV_{f} between a voltage V_{f1} of the first diode-connected BJT Q3 and a voltage V_{f2} of the second diode-connected BJT Q4 is expressed as Equation 6.
dV_{f}=V_{f1}−V_{f2}=ln(N)*V_{T} [Equation 6]

The second current I2 flowing the second PMOS transistor MP1_2 is expressed as Equation 7.

$$\begin{matrix}I 2 = I 2 A + I 2 B \\ = \frac{VB}{R 5} + \frac{{dV}_{f}}{R 6} \\ = \frac{{V}_{f 1}}{R 5} + \frac{ln ( N )}{R 6} * {V}_{T}\end{matrix} \qquad [ Equation 7 ]$$

Accordingly, the reference voltage VREF is expressed as Equation 8.

$$\begin{matrix}VREF = R 7 * I 3 \\ = R 7 * I 2 \\ = \frac{R 7}{R 5} * [ {V}_{f 1} + \frac{R 5}{R 6} * ln ( N ) * {V}_{T} ]\end{matrix} \qquad [ Equation 8 ]$$

Referring to Equation 8, a base-emitter (B-E) voltage V_{f1} of the first diode-connected BJT Q3 has a negative value with respect to the variation of temperature, and the thermal voltage V_{T} has a positive value with respect to the variation of temperature. As a result, the reference voltage VREF which does not sensitively vary according to the variation of temperature may be generated by adjusting (R5/R6)*ln(N). Further, dissimilar to the Equation 5, the reference voltage VREF can be reduced by adjusting a ratio of R7 and R5.

In the mean time, comparing Equation 5 of FIG. 1 with Equation 8 of FIG. 2, the BGR circuit relating to Equation 5 includes a coefficient value of ln(N*R2/R3), and the improved BGR circuit relating to Equation 8 includes a coefficient value of ln(N). Accordingly, in order to increase the reference voltage reference voltage VREF, the improved BGR circuit of Equation 8 requires a value of N larger than that of the BGR circuit of Equation 5.

Further, to adjust the amounts of the second and fourth sub-current I1B and I2B, the resistances of the first and second resistors R4 and R5 should be large.

As a result, a size of the improved BGR circuit relating to Equation 8 should be larger than that of the BGR circuit relating to Equation 5 because the value of N, and the resistances of the first and second resistors R4 and R5 are large. In addition, the second and fourth sub-current I1B and I2B continuously flows along two paths so that current consumption is also increased.

### SUMMARY OF THE INVENTION

It is, therefore, an object of the present invention to provide a band gap reference voltage generation circuit for operating under low voltage circumstances and reducing a current consumption and a size thereof.

In accordance with an aspect of the claimed invention, there is provided a band gap reference voltage generation circuit, including: an operational amplifier for receiving first and second voltages and outputting an operational amplified signal; a first voltage generator for generating the first voltage in response to the operational amplified signal; a second voltage generator for generating the second voltage in response to the operational amplified signal; a common current path unit connected between output nodes of the first and second voltage generators and generating a current path based on a common voltage level of the first and second voltages; and a reference voltage generator for generating a reference voltage based on the operational amplified signal.

In accordance with an aspect of the present invention, there is provided a semiconductor device for generating a reference voltage, including: an operational amplifier for receiving first and second voltages and outputting an operational amplified signal; a first voltage generator for generating the first voltage in response to the operational amplified signal; a second voltage generator for generating the second voltage in response to the operational amplified signal; a common current path unit connected between output nodes of the first and second voltage generators and generating a current path based on a common voltage level of the first and second voltages; and a reference voltage generator for generating a reference voltage based on the operational amplified signal.

### BRIEF DESCRIPTION OF THE DRAWINGG

The above and other objects and features of the present invention will become apparent from the following description of preferred embodiments taken in conjunction with the accompanying drawings, in which:

FIG. 1 is a block diagram of a band gap reference voltage generator of the related arts;

FIG. 2 is a block diagram of an improved band gap reference voltage generator of the related arts for operating under lower voltage circumstance;

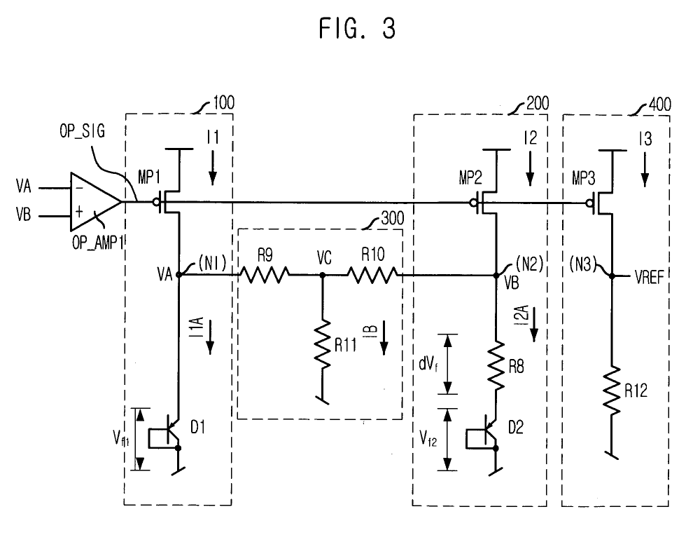

FIG. 3 is a block diagram of a band gap reference voltage generator in accordance with an embodiment of the claimed invention; and

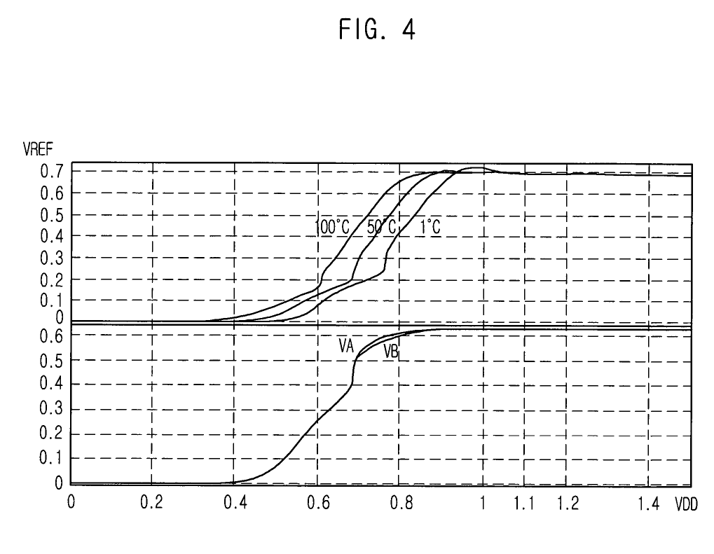

FIG. 4 is a timing diagram showing a simulation result of the band gap reference voltage generator shown in FIG. 3.

### DETAILED DESCRIPTION OF THE INVENTION

Hereinafter, a band gap reference voltage generation circuit in accordance with the present invention will be described in detail referring to the accompanying drawings.

FIG. 3 is a block diagram of a band gap reference voltage generator in accordance with an embodiment of the claimed invention.

Referring to FIG. 3, the band gap reference voltage generator includes an operational amplifier OP_AMP3, first and second voltage generators 100 and 200, a common current path unit 300, and a reference voltage generator 400.

The operational amplifier OP_AMP3 receives a first voltage VA and a second voltage VB to output an operational amplified signal OP_SIG. The first voltage generator 100 generates the first voltage VA in response to the operational amplified signal OP_SIG. The second voltage generator 200 generates the second voltage VB in response to the operational amplified signal OP_SIG. The common current path unit 300 is connected between a first node N1 of the first voltage VA and a second node N2 of the second voltage VB to thereby generate a current path according to a common voltage level between the first and second voltages VA and VB. The reference voltage generator 400 generates a reference voltage VREF based on the operational amplified signal OP_SIG.

In detail, the first voltage generator 100 includes a first PMOS transistor MP1 and a first diode-connected BJT D1. The first PMOS transistor MP1 has a source-drain path between a source voltage and the first node N1 of the first voltage VA and a gate for receiving the operational amplified signal OP_SIG. The first diode-connected BJT D1 whose base and collector are in common is connected between the first node N1 and a ground voltage.

The second voltage generator 200 includes a second PMOS transistor MP2, a first resistor R8 and a second diode-connected connected BJT D2. The second PMOS transistor MP2 has a source-drain path between the source voltage and the second node N2 of the second voltage VB and a gate for receiving the operational amplified signal OP_SIG. The first resistor R8 has one terminal connected to the second node N2 of the second voltage VB. The second diode-connected BJT D2 whose base and collector are in common is connected between the first resistor R8 and the ground voltage.

The common current path unit 300 includes second to fourth resistors R9, R10 and R11. The second resistor R9 is connected to the first node N1 of the first voltage VA. The third resistor R10 has one terminal connected to the second resistor R9 and the other terminal connected to the second node N2 of the second voltage VB. The fourth resistor R11 has one terminal connected to a common node VC of the second and third resistors R9 and R10 and the other terminal connected to the ground voltage.

The reference voltage generator 400 includes a third PMOS transistor MP3 and a fifth resistor R12. The third PMOS transistor M3 has a source-drain path between the source voltage and a third node N3 of the reference voltage VREF and a gate for receiving the operational amplified signal OP_SIG. The fifth resistor R12 is connected between the third node N3 of the reference voltage VREF and the ground voltage.

As described above, the common current path unit 300 of the claimed invention forms a common current path between the first voltage VA and the second voltage VB. As a result, a sub-current IB corresponding to the second and fourth sub-currents I1B and I2B of the improved BGR circuit shown in FIG. 2 flows through the common current path. In the claimed invention, the number of current paths is reduced, and thus, the current consumption may be reduced.

Hereinafter, a voltage level of the reference voltage VREF in accordance with the embodiment of the claimed invention is explained with formulas.

First, a voltage difference dV_{f} between a voltage V_{f1} of the first diode-connected BJT D1 and a voltage V_{f2} of the second diode-connected BJT D2 is expressed as Equation 9.
dV_{f}=V_{f1}−V_{f2}=ln(N)*V_{T} [Equation 9]

In the claimed invention, the second and third resistors R9 and R10 have substantially the same resistance, and voltage levels of the first and second voltages VA and VB are substantially the same value because they are input voltages of the operational amplifier OP_AMP3. Accordingly, the common node VC of the second and third resistors R9 and R10 has the same voltage level as those of the first and second voltages VA and VB.

In addition, the sub-current IB flowing the fourth resistor R11 has the same value as that of the second and fourth sub-currents I1B and I2B. Accordingly, the sub-current IB flows through the first and second PMOS transistors MP1 and MP2 by half, respectively. Herein, a second current I2 flowing through the second PMOS transistor MP2 is expressed as Equation 10.

$$\begin{matrix}I 2 = \frac{1}{2} * IB + I 2 A \\ = \frac{1}{2 } * \frac{VC}{R 11} + \frac{{dV}_{f}}{R 8} \\ = \frac{1}{2} * \frac{VA}{R 11} + \frac{ln ( N )}{R 8} * {V}_{T} \\ = \frac{{V}_{f 1}}{2 * R 11} + \frac{ln ( N )}{R 8 } * {V}_{T}\end{matrix} \qquad [ Equation 10 ]$$

In the claimed invention, because the first to third PMOS transistors MP1 to MP3 have the same dimension, i.e., a W/L ratio, a first current I1 flowing through the first PMOS transistor MP1 has the same value as those of the second current I2 flowing through the second PMOS transistor MP2 and a third current I3 flowing through the third PMOS transistor MP3. Accordingly, the reference voltage VREF is expressed as Equation 11.

$$\begin{matrix}VREF = R 12 * I 3 \\ = R 12 * I 2 \\ = \frac{R 12}{2 * R 11} * ( {V}_{f 1} + \frac{2 * R 11}{R 8} * ln ( N ) * {V}_{T} )\end{matrix} \qquad [ Equation 11 ]$$

Equation 8 relating to the improved BGR circuit of the related arts shown in FIG. 2 is expressed as follows.

$$\begin{matrix}VREF = R 7 * I 3 \\ = R 7 * I 2 \\ = \frac{R 7}{R 5} * [ {V}_{f 1} + \frac{R 5}{R 6} * ln ( N ) * {V}_{T} ]\end{matrix} \qquad [ Equation 8 ]$$

In comparison with Equations 8 and 11, the improved BGR circuit of the related arts has a value of (R5/R6) as a coefficient of a thermal voltage V_{T}. On the other hand, the band gap reference voltage generator of the claimed invention has a value of (2*R11/R8) as a coefficient of the thermal voltage V_{T}. When the improved BGR circuit of the related arts and the band gap reference voltage generator of the claimed invention generate the same reference voltage VREF, the band gap reference voltage generator of the claimed invention may reduce a value of the fourth resistor R11 and a size ratio of a diode, i.e., ln(N), compared to the improved BGR circuit of the related arts.

That is, the claimed invention forms the common current path between the first voltage VA and the second voltage VB so that the sub-current IB corresponding to the second and fourth sub-currents I1B and I2B of the improved BGR circuit shown in FIG. 2 flows through the common current path. As a result, in the claimed invention, the number of current paths is reduced, and thus, the current consumption may be reduced. Further, due to the reduced current consumption, the coefficient of the thermal voltage V_{T} shown in Equation 11, i.e., (2*R11/R8), is larger than those of Equations 5 and 8, i.e., (R2/R3) and (R5/R6). Accordingly, the value of the fourth resistor R11 or ln(N) may be reduced so that its size and current consumption may be reduced.

FIG. 4 is a timing diagram showing a simulation result of the band gap reference voltage generator shown in FIG. 3.

Referring to FIG. 4, the band gap reference voltage generator may generate the reference voltage VREF which does not sensitively vary according to variations of a temperature and a supplying voltage.

As described above, the claimed invention may implement the band gap reference voltage generator capable of operating under low voltage circumstances and reducing a current consumption and a size thereof. On demand for operating under low voltage circumstances to reduce current consumption and generation of heat, the band gap reference voltage generator of the claimed invention is more and more useful.

The present application contains subject matter related to Korean patent application Nos. 2005-91664 & 2005-132494, filed in the Korean Patent Office on Sep. 29, 2005 & Dec. 28, 2005, respectively, the entire contents of which being incorporated herein by reference.

While the present invention has been described with respect to the particular embodiments, it will be apparent to those skilled in the art that various changes and modifications may be made without departing from the spirit and scope of the invention as defined in the following claims.

What is claimed is:

1. A band gap reference voltage generation circuit, comprising:
an operational amplifier for receiving first and second voltages and outputting an operational amplified signal;
a first voltage generator for generating the first voltage in response to the operational amplified signal;
a second voltage generator for generating the second voltage in response to the operational amplified signal;
a common current path unit connected between output nodes of the first and second voltage generators and generating a current path based on a common voltage level of the first and second voltages; and
a reference voltage generator for generating a reference voltage based on the operational amplified signal.

2. The band gap reference voltage generation circuit as recited in claim 1, wherein the first voltage generator includes:
a first metal oxide semiconductor (MOS) transistor having a source-drain path between a source voltage terminal and the output node of the first voltage generator and a gate for receiving the operational amplified signal; and
a first diode connected between the output node of the first voltage generator and a ground voltage terminal.

3. The band gap reference voltage generation circuit as recited in claim 2, wherein the second voltage generator includes:
a second MOS transistor having a source-drain path between the source voltage terminal and the output node of the second voltage generator and a gate for receiving the operational amplified signal;
a first resistor having one terminal connected to said output node; and
a second diode connected between the other terminal of the first resistor and the ground voltage terminal.

4. The band gap reference voltage generation circuit as recited in claim 3, wherein each of the first and second diodes is a bipolar junction transistor whose base and collector are in common.

5. The band gap reference voltage generation circuit as recited in claim 3, wherein the common current path unit includes:
a second resistor connected to the output node of the first voltage generator;
a third resistor having one terminal connected to the second resistor and the other terminal connected to the output node of the second voltage generator; and
a fourth resistor having one terminal connected to a common node of the second and third resistors and the other terminal connected to the ground voltage terminal.

6. The band gap reference voltage generation circuit as recited in claim 5, wherein the reference voltage generator includes:
a third MOS transistor having a source-drain path between the source voltage terminal and an output node of the reference voltage generator and a gate for receiving the operational amplified signal; and
a fifth resistor connected between said output node and the ground voltage terminal.

7. The band gap reference voltage generation circuit as recited in claim 6, wherein the first to third MOS transistors are PMOS transistors.

8. The band gap reference voltage generation circuit as recited in claim 6, wherein the first to third MOS transistors have substantially the same width/length (W/L) ratio.

9. The band gap reference voltage generation circuit as recited in claim 6, wherein the first to third resistors have substantially the same resistance.

10. A semiconductor device for generating a reference voltage, comprising:
an operational amplifier for receiving first and second voltages and outputting an operational amplified signal;
a first voltage generator for generating the first voltage in response to the operational amplified signal;
a second voltage generator for generating the second voltage in response to the operational amplified signal;
a common current path unit connected between output nodes of the first and second voltage generators and generating a current path based on a common voltage level of the first and second voltages; and
a reference voltage generator for generating a reference voltage based on the operational amplified signal.

11. The semiconductor device as recited in claim 10, wherein the first voltage generator includes:
a first metal oxide semiconductor (MOS) transistor having a source-drain path between. a source voltage terminal and the output node of the first voltage generator and a gate for receiving the operational amplified signal; and
a first diode connected between the output node of the first voltage generator and a ground voltage terminal.

12. The semiconductor device as recited in claim 11, wherein the second voltage generator includes:
a second MOS transistor having a source-drain path between the source voltage terminal and the output node of the second voltage generator and a gate for receiving the operational amplified signal;
a first resistor having one terminal connected to said output node; and
a second diode connected between the first resistor and the ground voltage terminal.

13. The semiconductor device as recited in claim 12, wherein each of the first and second diodes is a bipolar junction transistor whose base and collector are in common.

14. The semiconductor device as recited in claim 12, wherein the common current path unit includes:
a second resistor connected to the output node of the first voltage generator;
a third resistor having one terminal connected to the second resistor and the other terminal connected to the output node of the second voltage generator; and
a fourth resistor having one terminal connected to a common node of the second and third resistors and the other terminal connected to the ground voltage terminal.

15. The semiconductor device as recited in claim 14, wherein the reference voltage generator includes:
a third MOS transistor having a source-drain path between the source.voltage terminal and an output node of the reference voltage generator and a gate for receiving the operational amplified signal; and
a fifth resistor connected between said output node and the ground voltage terminal.

16. The semiconductor device as recited in claim 15, wherein the first to third MOS transistors are PMOS transistors.

17. The semiconductor device as recited in claim 15, wherein the first to third MOS transistors have substantially the same width/length (W/L) ratio.

18. The semiconductor device as recited in claim 15, wherein the first to third resistors have substantially the same resistance.
